(19) United States
(12) Patent Application Publication
(10) Pub. No.: US 2007/0212514 A1
(43) Pub. Date: Sep. 13, 2007

(54) Thin Film Material and Method for Producing Same

(75) Inventors: Jian-guo Huang, Wako-Shi (JP); Toyoki Kunitake, Wako-Shi (JP)

Correspondence Address: BIRCH STEWART KOLASCH & BIRCH, PO BOX 747, FALLS CHURCH, VA, 22040-0747, US

(73) Assignee: Riken, Saitama (JP)

(21) Appl. No.: 10/558,402

(22) PCT Filed: May 28, 2004
(86) PCT No.: PCT/JP04/07749

§ 371 Date: Sep. 7, 2006

(30) Foreign Application Priority Data
May 29, 2003 (JP) 2003-153014

(51) Int. Cl. B32B 7/00; B05D 3/00

(52) U.S. Cl. 428/98; 427/299; 427/331

(57) ABSTRACT

There is disclosed a method for producing a thin film material, comprising plugging pores in a surface of a porous substrate with a polymer compound, forming a metal oxide thin film or an organic/metal oxide composite thin film on the plugged porous substrate, and removing the polymer compound or both of the polymer compound and an organic compound in the thin film. The metal oxide thin film or the organic/metal oxide composite thin film can be uniformly formed without defects directly on the porous substrate by the method.

### TECHNICAL FIELD

The present invention relates to a method for producing a thin film material and a thin film material. More specifically the invention relates to a method for producing a thin film material by forming a self-supportable metal oxide thin film or organic/metal oxide composite thin film directly on a porous substrate, and a thin film material.

### BACKGROUND ART

Metal oxide thin film materials with thicknesses controlled at nano level have been expected to play important roles in various fields of improvement of chemical, mechanical, optical properties of materials, catalysts, separation of substances such as gases, production of various sensors, high-density electronic devices, etc. There has been demand for producing an insulation thin film with remarkably high accuracy in next-generation, 10- to 20-nm integrated circuit technologies, and also in production of high-density memories and thin film magnetic storage heads.

Composite materials comprising organic compounds and metal oxides can have mechanical, physical, and chemical properties different from those of each component, and thereby development thereof has strongly been demanded in various fields. Actually, composite materials comprising polymer compounds and metal oxides have mechanical properties including rigidity of the polymers and inflexibility of the oxides, and are regarded as one of important structural materials today. Further, the composite materials comprising the polymer compounds and metal oxides are excellent in elasticity, abrasion resistance, and chemical stability, and are expected as future tires and shielding materials, etc. Wide application of the metal oxide materials containing the organic molecules to coloring of common materials, novel optical devices, etc. is being elucidated. Further, composite materials mixed at a molecular or atomic level may show radically new properties never seen before.

Most of these materials show practical advantages only in the state of thin films. For example, higher integration of electronic devices has been an important technological object in the semiconductor industry today, and a stable insulation thin film having a thickness controlled at nano level is essential thereto. Further, a thin film having appropriate softness and abrasion resistance, which are apparently incompatible, is needed for precision electronics devices such as hard disks to cause mechanical friction.

Further, a thin film coating technology with excellent reflection efficiency has been studied in the field of optoelectronics, which is expected to be put into practical use. An important technological object is development of a process for producing a stacked thin film, accurate and uniform at nano level. Particularly, in production of optical fibers and optical guides, establishment of a technology for coating a substrate having a dense complicated shape with a thin film has been imperative. An important target for producing SHG devices is a composite thin film containing regularly arranged organic molecules such as dyes with large polarizability.

One of the inventors has filed patent applications on methods for producing a metal oxide thin film and an organic/metal oxide composite thin film (see JP-A-9-241008, claims and paragraphs [0018] to [0024], and JP-A-10-249985, claims and paragraphs [0013] to [0022]). A metal oxide thin film or organic/metal oxide composite thin film can be certainly formed with excellent thickness accuracy by the methods.

When an organic/metal oxide composite thin film is prepared by the above method using an organic low molecular compound and the organic compound is removed under mild conditions by an aqueous ammonia treatment, etc., a metal oxide thin film having pores corresponding to the structure of the compound can be obtained, and such a thin film can be used for separation and detection of enantiomers (see, e.g. JP-A-2000-254462, claims and paragraphs [0008] to [0017]).

When an organic/metal oxide composite thin film is prepared by the above method using an organic compound and the organic compound is removed by an oxygen plasma treatment, an amorphous metal oxide thin film can be obtained, and such a thin film can have an excellent ultra low dielectric property and can be used in insulation materials for 10- to 20-nm-patterned circuits.

The above thin film materials are formed on substrates, and it is desirable that the materials are in the thin film state even when the substrates are removed from the materials in view of wider applications. Thus, the thin films preferably have self-supportability. In this description, the term “self-supportability” means not only a property that the thin film maintains its three-dimensional shape before and after removing the substrate but also a property that the thin film is not deformed into a block irreversibly and has a surface area sufficiently larger than its thickness after removing the substrate. The self-supportability can be evaluated by a method used in a test example to be hereinafter described.

Many self-supportable thin film materials have been produced and used. However, only several techniques are known in the world as methods for producing a self-supportable ultrathin film material having a thickness of at most several hundreds nanometers, and they are not practical.

For example, in one method for producing a separation film having an ultrathin separation layer on a porous substrate, the ultrathin separation layer is formed directly on the porous substrate by interfacial polymerization, electrolytic polymerization, vapor deposition, etc. However, this method is suitable only for producing a thin film comprising single component of a polymer or a metal oxide, and the surface ultrathin layer on the resultant film cannot be closely controlled. A film material prepared by fixing a self-supportable thin film having a structure closely controlled at a molecular or atomic level to a porous substrate is expected to be an optimum material for overcoming such a situation.

For example, as a method for producing a submicron-thick, self-supportable, composite thin film material, a method, which comprises forming a composite film having a layered structure on a solid substrate by a so-called layer-by-layer adsorption and detaching the composite film from the substrate, has been proposed (WO 01/72878A1, page 16 and claims). In this method, the thin film structure can be freely controlled by selecting the order and number of the adsorption. However, the film components are limited, and thus the method has not become common. Particularly, the method is not suitable for stacking the above-mentioned composite thin film comprising a metal oxide and an organic compound.

Further, one of the inventors has filed a patent application also on a method for producing a thin film material, comprising forming a polymer thin film having a hydroxyl or carboxyl group on a solid substrate, forming a metal oxide thin film layer or an organic/metal oxide composite thin film layer on the polymer thin film, and detaching a thin film material having the polymer thin film and the metal oxide thin film layer or organic/metal oxide composite thin film from the solid substrate (Japanese Patent Application No. 2002-134314). In this method, the thin film material can have a self-supportable metal oxide thin film layer or organic/metal oxide thin film layer having a thickness controlled at nano level. However, this method comprises an operation of transferring the formed ultrathin film onto the porous substrate, and it is difficult to uniformly transfer the ultrathin film without wrinkling. Further, in the step of transferring the formed ultrathin film of the above method, there is a fear that breakage or defects are generated in the ultrathin film.

An object of the invention is to solve the above problems, thereby providing a method capable of forming a uniform metal oxide thin film or organic/metal oxide composite thin film without defects directly on a porous substrate to produce a thin film material, and a thin film material.

### DISCLOSURE OF THE INVENTION

The present inventors have intensely researched a method for forming a uniform metal oxide thin film or organic/metal oxide composite thin film with no defects directly on a porous substrate to produce a thin film material without a procedure of transferring the thin film from a support onto a porous substrate. As a result, the inventors have found that, by plugging a porous substrate with a polymer compound or by forming an intermediate thin film on a porous substrate, a uniform thin film material with no defects can be formed without influences of pores on the porous substrate, and the present invention has been accomplished based on the finding.

Thus, the object of the invention can be achieved by the following producing method.

(1) A method for producing a thin film material, comprising plugging at least pores in a surface of a porous substrate with at least one type of a polymer compound, forming a metal oxide thin film or an organic/metal oxide composite thin film on the plugged porous substrate surface, and removing the polymer compound or an organic compound contained in the organic/metal oxide composite thin film.

(2) A method for producing a thin film material, comprising forming an intermediate thin film on a porous substrate, forming a metal oxide thin film or an organic/metal oxide composite thin film on the formed intermediate thin film, and removing the intermediate thin film or both of the intermediate thin film and an organic compound contained in the organic/metal oxide composite thin film.

In the producing method of the invention, it is preferred that, in the step of forming the metal oxide thin film or organic/metal oxide composite thin film, the following processes are carried out at least once: (a) a process of bringing a metal compound or a combination of (the metal compound+an organic compound) into contact with a surface of the substrate containing the polymer compound or a thin film, the metal compound having a group capable of undergoing a condensation reaction with a hydroxyl group or a carboxyl group on the surface and then being hydrolyzed to generate a hydroxyl group, and (b) a process of hydrolyzing the metal compound present on the surface of the substrate or the thin film. It is preferred that the processes of (a) and (b) are carried out a plurality of times using plural types of the metal compounds or combinations of (the metal compound+the organic compound).

Further, in the producing method of the invention, it is preferred in that, in the step of forming the metal oxide thin film or the organic/metal oxide composite thin film, the following processes are carried out at least once: (a) a process of bringing a metal compound or a combination of (the metal compound+an organic compound) into contact with a surface of the substrate containing the polymer compound or a thin film, the metal compound having a group capable of undergoing a condensation reaction with a hydroxyl group or a carboxyl group on the surface and then being hydrolyzed to generate a hydroxyl group, (b) a process of hydrolyzing the metal compound present on the surface of the substrate or the thin film, and (c) a process of bringing a cationic polymer compound or an organic compound with or without a surface hydroxyl or carboxyl group into contact with the surface, to form the organic compound thin film on the surface.

The above polymer compound, the intermediate thin film, and/or the organic compound contained in the organic/metal oxide composite thin film are preferably removed by at least one treatment selected from oxygen plasma treatments, ozone oxidation treatments, burning treatments, and dissolution treatments.

Further, the object of the invention can be achieved by the following thin film material.

(1) A thin film material comprising a structure provided from a body comprising a porous substrate having pores plugged with at least one type of a polymer compound and a metal oxide thin film or an organic/metal oxide composite thin film formed on the porous substrate by removing a portion corresponding to the polymer compound or both of the polymer compound and an organic compound contained in the organic/metal oxide composite thin film from the body.

(2) A thin film material comprising a structure provided from a body comprising an intermediate thin film and a metal oxide thin film or organic/metal oxide composite thin film formed in this order on a porous substrate by removing a portion corresponding to the intermediate thin film or both of the intermediate thin film and an organic compound contained in the organic/metal oxide composite thin film from the body.

The thin film material of the invention may further comprise an organic compound thin film on the above metal oxide thin film or organic/metal oxide composite thin film.

The thin film material of the invention preferably has a thickness of 2 to 300 nm and an area of 25 mm² or more. In the thin film material of the invention, the polymer compound, the intermediate thin film, and/or the organic compound contained in the organic/metal oxide composite thin film are preferably removed by at least one treatment selected from oxygen plasma treatments, ozone oxidation treatments, burning treatments, and dissolution treatments. The thin film material of the invention is preferably produced by the method of the invention. Further, the thin film material of the invention preferably has self-supportability.

In the producing method of the invention, at least the pores in the porous substrate surface are plugged with at least one type of the polymer compound, the metal oxide thin film or organic/metal oxide composite thin film is formed on the substrate, and the polymer compound plugging the pores is removed, or alternatively the intermediate thin film is formed on the porous substrate, the metal oxide thin film or organic/metal oxide composite thin film is formed on the intermediate thin film, and the intermediate thin film or both of the intermediate thin film and the organic compound contained in the organic/metal oxide composite thin film are removed. Thus, in the producing method of the invention, a uniform thin film material without defects can be formed directly on the porous substrate without an operation of transferring the formed thin film onto another porous substrate, which is needed in conventional producing methods.

The thin film material of the invention has the structure formed by removing the polymer compound, the intermediate thin film, and/or the organic compound contained in the organic/metal oxide composite thin film from the body having the metal oxide thin film or organic/metal oxide composite thin film on the porous substrate with the pores plugged with the at least one polymer compound or on the intermediate thin film formed on the porous substrate. Thus, according to the invention, there can be provided a thin film material having a uniform, flat, self-supportable, metal oxide thin film or organic/metal oxide composite thin film on a porous substrate.

### BRIEF DESCRIPTION OF THE DRAWINGS

FIG. 1 is a schematic cross-sectional view for illustrating a vacuum filtration apparatus used in the present invention. In this view, 1 represents a glass funnel, 2 represents a porous alumina substrate, and 3 represents a flask.

FIG. 2 shows scanning electron microscope images of a porous alumina substrate used in Examples in the invention.

In the drawings, 4 represents a plugged porous alumina substrate, 5 represents a polystyrene support ring, 6 represents a two-sided tape, and 7 represents a silicon wafer.

FIG. 3 shows scanning electron micrograms of a titania thin film material produced in Example 1 before an oxygen plasma treatment.

FIG. 4 shows scanning electron micrograms of the titania thin film material produced in Example 1 after the oxygen plasma treatment.

FIG. 5 shows scanning electron micrograms of a silica thin film material produced in Example 2 before an oxygen plasma treatment.

FIG. 6 shows scanning electron micrograms of the silica thin film material produced in Example 2 after the oxygen plasma treatment.

FIG. 7 shows scanning electron micrograms of a silica thin film material produced in Example 3 after an oxygen plasma treatment.

### DETAILED DESCRIPTION OF THE INVENTION

The producing method and the thin film material of the present invention are described in detail below.

It should be noted that, in this description, the term “numeric value to numeric value” means a range including both the numeric values as the minimum value and maximum value.

[Method for Producing Thin Film Material]

The producing method of the invention comprises plugging at least pores in a surface of the porous substrate with at least one type of the polymer compound.

In this description, the term “the pores are plugged with the polymer compound” means not only that a solution prepared by dissolving the polymer compound in an appropriate solvent is introduced into at least a plurality of the pores in the surface of porous substrate to fill the pores with the solution, but also that inside of the pores and the surface of the porous substrate are coated with the solution of the polymer compound.

<Porous Substrate>

The porous substrate used for the producing method of the invention is not particularly limited as long as it has a plurality of internal pores (through-holes) and is not removed in the step of removing the polymer compound, the intermediate thin film, and/or the organic compound contained in the organic/metal oxide composite thin film. It is preferred that the porous substrate has on the surface a reactive group (preferably a hydroxyl or carboxyl group) capable of reacting with the metal compound or the combination of (the metal compound+the organic compound). Specific examples of the porous substrates include solid substrates of porous metals such as silicon and aluminum, solid substrates of porous inorganic materials such as glasses, titanium oxide, alumina, zirconia, and silica, and solid substrates of porous organic materials such as polycarbonate films. The porous substrate is particularly preferably a porous alumina disk.

There are no particular restrictions on the size, shape, etc. of the porous substrate for the producing method of the invention. In the producing method of the invention, the pores in the surface of the porous substrate are plugged with the polymer compound, whereby the porous substrate does not have to comprise a flat surface, and may be appropriately selected from substrates having various materials and sizes. For example, the porous substrate may have a various shape and may be a plate-shaped solid substrate, a solid substrate with an irregular surface, etc.

<Polymer Compound>

The polymer compound for plugging the pores in the surface of the porous substrate is not particularly limited as long as it can be dissolved in a solvent into a liquid and the obtained solution can be introduced into at least the pores in the surface of the porous substrate to plug the pores. The polymer compound preferably provides a reactive group (preferably a hydroxyl or carboxyl group) on the surface including the plugged pores. It is preferred that the polymer compound provides a plurality of the reactive groups from the viewpoint of adsorbing the metal compound or the combination of (the metal compound+the organic compound) more strongly. Examples of the polymer compounds include polyvinyl alcohols, polyvinyl phenols, polyacrylic acids, polymethacrylic acids, polymethyl methacrylates, poly(2-hydroxyethyl methacrylate)s, polyglutamic acids, polyserines, amyloses, colominic acids, etc.

Also cationic polymer compounds can be preferably used as the polymer compound. Metal alkoxides and metal oxides can interact like anions with cations of the cationic polymer compounds, resulting in strong adsorption. Specific examples of the cationic polymer compounds preferred in the invention include PDDAs (polydimethyldiallylammonium chlorides), polyethyleneimines, polylysines, chitosans, amino-ended dendrimers, etc.

The solvent for dissolving the polymer compound may be appropriately selected depending on the polymer compound. Examples of the solvents include water, methanol, ethanol, propanol, toluene, carbon tetrachloride, chloroform, cyclohexane, and benzene, and they may be used singly or as a mixture thereof.

The amount of the reactive group (preferably the hydroxyl or carboxyl group) on the surface of the polymer compound plugging the pores of the porous substrate affects the density of the metal oxide thin film or organic/metal oxide composite thin film to be formed. To form an excellent metal oxide thin film or organic/metal oxide composite thin film, the amount of the reactive group is generally 5.0×10¹³ to 5.0×10¹⁴ equivalent/cm², preferably 1.0×10¹⁴ to 2.0×10¹⁴ equivalent/cm².

In the producing method of the invention, at least the pores in the surface of the porous substrate (preferably the pores in the surface of the porous substrate and the porous substrate surface) are plugged with at least one type of the polymer compound. The ratio of the plugged pores to all pores in the porous substrate surface is preferably 80% or more, more preferably 90% or more, and it is most preferred that all the pores are plugged. Further, it is preferable to use 2 or more types of the polymer compounds from the viewpoint of plugging the pores in the porous substrate at a higher rate.

There are no particular restrictions on the method for plugging the pores existing in the porous substrate surface with the polymer compound. For example, the pores in the porous substrate surface may be plugged by a method (a dip coating method) of soaking the porous substrate in a solution of the polymer compound and an organic solvent to introduce the solution into the pores, a method of applying the solution to the porous substrate surface, a method of spin-coating the porous substrate with the solution, or a method of soaking the porous substrate in the solution and aspirating the solution under reduced pressure through the pores to fill the pores with the solution, etc.

<Intermediate Thin Film>

In the producing method of the invention, the intermediate thin film may be formed on the porous substrate, instead of plugging the pores in the surface of the porous substrate with at least one type of the polymer compound. By forming the intermediate thin film directly on the porous substrate without plugging the pores in the porous substrate surface, influence of the pores in the porous substrate surface on the metal oxide thin film or organic/metal oxide composite thin film to be formed thereafter can be prevented.

A compound for the intermediate thin film are not particularly limited as long as it is an organic compound that can be removed by at least one treatment selected from the oxygen plasma, ozone oxidation, burning, and dissolution treatments to be hereinafter described. It is preferred that the organic compound can provide a reactive group (preferably a hydroxyl or carboxyl group) in the forming surface. Specific examples of the organic compounds include the above polymer compounds, and polyvinylpyrrolidones, acrylic acid copolymers, etc.

The intermediate thin film may be formed by a method of coating the porous substrate with a solution prepared by dissolving the organic compound for the intermediate thin film in a solvent, a method of soaking the porous substrate in the solution, or a method of placing the intermediate thin film prepared beforehand on the porous substrate, etc. In the coating method and the soaking method, a high-viscosity solution is preferably used to prevent the pores in the porous substrate from affecting the intermediate thin film surface.

<Metal Oxide Thin Film or Organic/Metal Oxide Composite Thin Film>

The producing method of the invention comprises forming the metal oxide thin film or organic/metal oxide composite thin film on the plugged porous substrate or the intermediate thin film. The metal oxide thin film or organic/metal oxide composite thin film can be formed such that the metal compound or the combination of (the metal compound+the organic compound) is brought into contact with the porous substrate surface or the intermediate thin film surface and then hydrolyzed, the metal compound having a group that can be condensation-reacted with the reactive group (preferably the hydroxyl or carboxyl group) on the plugged porous substrate surface or the intermediate thin film surface and then hydrolyzed to generate a hydroxyl group.

There are no particular restrictions on the metal compound used in the above step as long as it can undergo a condensation reaction with the reactive group on the plugged porous substrate surface (including the surface of the polymer compound plugging the pores) and be hydrolyzed to generate a hydroxyl group. The metal compound is preferably a known metal compound that can be condensation-reacted with the hydroxyl or carboxyl group on the porous substrate surface or the polymer compound surface in the plugged pores and be hydrolyzed to generate a hydroxyl group. Typical examples of the metal compounds include metal alkoxide compounds such as titanium butoxide (Ti(O-nBu)₄), zirconium propoxide (Zr(O-nPr)₄), aluminum butoxide (Al(O-nBt)₃), niobium butoxide (Nb(O-nBu)₅), silicon tetramethoxide (Si(O—Me)₄), and boron ethoxide (B(O—Et)₃); metal alkoxides having 2 or more alkoxyl groups such as methyltrimethoxysilane (MeSi(O—Me)₃) and diethyldiethoxysilane (Et₂Si (O—Et)₂); metal alkoxides having 2 or more alkoxyl groups with a ligand such as acetylacetone; rare earth metal alkoxides such as lanthanide isopropoxide (Ln(O-iPr)₃) and yttrium isopropoxide (Y(O-iPr)₃); and double alkoxide compounds such as BaTi(OR)ₓ.

In addition to the above metal alkoxides, alkoxide sol or gel particles prepared by adding a small amount of water to the metal alkoxides to partially hydrolyze and condensate them, binuclear or cluster alkoxide compounds having a plurality of or plural types of metal elements such as titanium butoxide tetramer (C₄H₉O[Ti(OC₄H₉)₂O]₄C₄H₉), and polymers based on metal alkoxide compounds one-dimensionally cross-linked via oxygen atoms can be used as the metal alkoxide group in the invention.

The metal compounds used in the invention further include metal complexes that can be adsorbed to the reactive group on the porous substrate or the intermediate thin film and can be hydrolyzed to generate a hydroxyl group on the surface. Specific examples of the metal complexes include metal halides such as cobalt chloride (COCl₂), metal carbonyl compounds such as titanium oxoacetylacetate (TiO(CH₃COCH₂COO)₂) and pentacarbonyl iron (Fe(CO)₅), and multinuclear clusters thereof.

The above metal compounds may be used in combination with each other. By combining different metal compounds, a composite metal compound thin film can be formed on the plugged porous substrate.

The solvent for dissolving the metal compound is not particularly limited, and for example, methanol, ethanol, propanol, toluene, carbon tetrachloride, chloroform, cyclohexane, benzene, etc. may be used singly or as a mixture thereof generally in the case of the metal alkoxide. The concentration of the metal compound in the solution is preferably about 10 to 100 mM.

In the producing method of the invention, the organic/metal oxide thin film comprising the metal compound and the organic compound may be formed on the plugged porous substrate surface or the intermediate thin film surface in addition to or instead of the metal oxide thin film. The organic compound usable in the invention is not particularly restricted as long as it can be dissolved in the solvent used in formation of the organic/metal oxide composite thin film. The organic compound may be a polymer compound, which may be the same as or different from the above polymer compound, or another organic compound. The term “the organic compound can be dissolved” means not only that the organic compound can be dissolved singly but also that the organic compound such as 4-phenylazobenzoic acid can be converted to a composite with a metal alkoxide and thereby dissolved in the solvent such as chloroform. Also the molecular weight of the organic compound is not particularly limited.

It is preferred that the organic compound usable in the invention has a plurality of the hydroxyl or carboxyl groups and is solid at room temperature (25° C.) from the viewpoint of stronger adsorption. Preferred examples of the organic compounds include polymer compounds having a hydroxyl or carboxyl group such as polyacrylic acids, polyvinyl alcohols, polyvinyl phenols, polymethacrylic acids, and polyglutamic acids; polysaccharides such as starchs, glycogens, and colominic acids; disaccharides and monosaccharides such as glucose and mannose; and porphyrin compounds and dendrimers having an end of a hydroxyl or carboxyl group.

Also the above-mentioned cationic polymer compounds can be preferably used as the organic compound. Metal alkoxides and metal oxides can interact like anions with cations of the cationic polymer compounds, resulting in strong adsorption.

These organic compounds can act not only as a structural component for forming a thin film with high mechanical strength, but also as a functional component for introducing a function to the resultant thin film material or a template component that is removed after the film formation to form pores corresponding to the molecular shape in the thin film.

In the producing method of the invention, to form the metal oxide thin film or organic/metal oxide composite thin film, a solution containing the metal compound or the combination of (the metal compound+the organic compound) is brought into contact with the plugged porous substrate surface or the intermediate thin film surface. There are no particular restrictions on the method for bringing the solution containing the metal compound or the combination of (the organic compound+the metal oxide) into contact with the plugged porous substrate surface or the intermediate thin film surface, and for example, the contact may be achieved by a method (a dip coating method) of soaking the plugged porous substrate or the intermediate thin film-formed porous substrate in the solution of the metal compound or the combination of (the organic compound+the metal oxide), a method of applying the solution to the plugged porous substrate surface or the intermediate thin film surface using a spin coating process, an alternate adsorption method, etc.

When the solution containing the metal compound or the combination of (the metal compound+the organic compound) is adsorbed to the plugged porous substrate surface or the intermediate thin film surface, the metal compound or the combination of (the metal compound+the organic compound) is chemically adsorbed strongly, and further excess part thereof is physically adsorbed weakly, to the porous substrate surface or the intermediate thin film surface. By washing the resultant at an appropriate temperature for an appropriate time, only the weakly adsorbed excess part is removed, thereby providing the nanometer-level thin film of the metal compound or the combination of (the metal compound+the organic compound) strongly adsorbed to the porous substrate surface or the intermediate thin film surface. In the case of using a spin coating method, etc., the adsorbed layer has a uniform thickness, and thereby can be used for forming the thin film without the washing.

In this description, the term “chemical adsorption” means formation of a chemical bond (such as a covalent bond, a hydrogen bond, and a coordinate bond) or an electrostatic bond (such as an ionic bond) between a reactive group (preferably a hydroxyl or carboxyl group) on a film forming surface and a metal compound, a metal ion, or a combination of (a metal compound+an organic compound).

The contact time and the contact temperature in the above step depend on activity of the metal compound or the combination of (the metal compound+the organic compound) and thereby are not clearly limited, and generally the time may be 1 to 20 minutes and the temperature may be room temperature to 50° C.

Further, in the chemical adsorption, a catalyst such as an acid and a base may be used to largely reduce the time of the step.

When the metal compound or the combination of (the metal compound+the organic compound) is brought into contact with the porous substrate surface plugged with the polymer compound or the intermediate thin film surface by an adsorption method, the chemically adsorbed metal compound or combination of (the metal compound+the organic compound) and the physically adsorbed excess metal compound or combination of (the metal compound+the organic compound) exist on the film forming surface.

In this case, the excessively adsorbed metal compound or combination of (the metal compound+the organic compound) may be removed in the producing method of the invention. Thus, in the case of removing the excess metal compound or combination of (the metal compound+the organic compound) existing on the plugged porous substrate surface or the intermediate thin film surface, because the metal oxide thin film or organic/metal oxide composite thin film is proportional to the amount of the metal compound or combination chemically adsorbed to the surface, the thin film can be formed with excellent accuracy and high reproducibility based on the amount.

The method for removing the excess metal compound or combination of (the metal compound+the organic compound) is not particularly limited as long as it can remove the excess metal compound or combination selectively. Preferred examples of the methods include washing with the solvent for dissolving the metal compound or combination of (the metal compound+the organic compound). Preferred washing methods include methods of soaking in the solvent, spray washing methods, steam washing methods, etc. The washing temperature is preferably equal to the temperature in the contact process.

In a case where a layer of the excessively adsorbed metal compound or combination of (the metal compound+the organic compound) is formed by the spin coating method, etc. in the manner that approximately all the solvent is removed, the layer is uniform over the entire film surface and thereby can be used as a film component without removing. Thus, the hydrolyzation of the metal compound to be hereinafter described can be carried out without washing the excess metal compound or combination of (the metal compound+the organic compound). In this case, the thickness of the metal oxide thin film or organic/metal oxide composite thin film can be controlled at nano level by selecting the concentration of the solution containing the metal compound or combination of (the metal compound+the organic compound), the spinning speed, and the spinning time, to change the thickness of the excessively adsorbed layer.

In the producing method of the invention, after the above process, the metal compound existing on the substrate surface or thin film forming surface is hydrolyzed. The metal compound is condensed in the hydrolyzation to form the metal oxide thin film or the organic/metal oxide composite thin film.

The hydrolyzation may be carried out using a known method without particular restrictions. For example, the most common hydrolyzation process is such that the porous substrate, which the metal compound or combination of (the metal compound+the organic compound) is adsorbed to or the intermediate thin film is formed on, is soaked in water. In view of preventing the penetration of impurities, etc. to form high-purity metal oxide, ultra pure water or ion-exchange water is preferably used for the soaking. Further, a catalyst such as an acid and a base may be used to largely shorten the hydrolyzation time.

In a case where the metal compound has a high reactivity with water, it may be reacted with water vapor in the air to be hydrolyzed.

After the hydrolyzation, the surface is dried by a drying gas such as nitrogen gas if necessary, to obtain the metal oxide thin film or organic metal compound composite thin film.

In the invention, the thickness of the metal oxide thin film or organic/metal oxide composite thin film can be controlled at nano level by repeating the processes at least once.

Thus, the thickness of the metal oxide thin film or organic metal compound composite thin film can be controlled such that the processes of chemically adsorbing the metal compound or combination of (the metal compound+the organic compound) using the surface hydroxyl group formed by the hydrolyzation, removing the excess metal compound or combination, and hydrolyzation are repeated at least once, preferably 10 times or more, more preferably 20 times or more.

The metal oxide thin film or organic/metal oxide composite thin film can be formed on the plugged porous substrate surface or the intermediate thin film surface by the above processes. In the case of using the above compound having a plurality of hydroxyl or carboxyl groups as the metal compound or the organic compound, a hydroxyl group can be disposed on the thin film even after forming the thin film. Thus, in this case, the hydroxyl group on the thin film can be used for forming another metal oxide thin film or organic/metal oxide composite thin film by the above processes. It is also possible to form a further metal oxide thin film or organic/metal oxide composite thin film thereon, so that a multilayer structure of the metal oxide thin films and/or organic/metal oxide composite thin films having various types and thicknesses at nano level can be formed one by one by repeating the processes.

In the producing method of the invention, by repeating the processes, the metal oxide thin film or organic/metal oxide composite thin film of several nanometers to several tens nanometers can be formed on the porous substrate with excellent accuracy. In the case of using a metal alkoxide having one metal atom such as titanium butoxide for forming the metal oxide thin film or organic/metal oxide composite thin film, films having thicknesses of several tens nanometers can be successively stacked depending on the adsorption conditions. In this case, the thickness increase per 1 cycle corresponds to adsorption of a monomolecular layer of the metal alkoxide. On the other hand, in the case of using alkoxide gel microparticles, etc, a thin film having a thickness of about 60 nm can be stacked in 1 cycle. Further, in the case of using the spin coating method for forming the metal oxide thin film or organic/metal oxide composite thin film, the thickness can be controlled within the range of several nanometers to 200 nm by selecting the solvent, the alkoxide content, the spinning speed, etc. In the case of using polyacrylic acid as the organic compound, a thin film having a thickness of several tens nanometers can be formed depending on the contact conditions. In the invention, by controlling the successive stacking of the metal oxide thin film and/or the organic/metal oxide composite thin film, the thin film with the above thickness accuracy can be appropriately produced.

Further, by changing the metal compound or the organic compound in this process, a composite thin film stack with a hybrid layer structure can be obtained.

<Organic Compound Thin Film>

The producing method of the invention may comprise bringing an organic compound or a cationic polymer compound, which has a hydroxyl or carboxyl group on the surface, into contact with the metal oxide thin film or organic/metal oxide composite thin film, to form an organic compound thin film on the thin film forming surface. The organic compound thin film is formed on the metal oxide thin film or organic/metal oxide composite thin film and can act as a protective film. The organic compound thin film has a surface hydroxyl or carboxyl group, whereby another metal oxide thin film or organic/metal oxide composite thin film can be formed on the organic compound thin film surface.

The compounds usable for the organic/metal oxide composite thin film can be preferably used as the organic compound or cationic polymer compound for the organic/metal oxide composite thin film. The method for bringing the organic compound or cationic polymer compound into contact with the thin film forming surface is not particularly limited, and various methods such as coating methods, soaking methods, and dip coating methods described for the metal oxide thin film or organic/metal oxide composite thin film can be preferably used for the contact. The contact conditions may be appropriately selected depending on the type of the organic compound or cationic polymer compound.

<Method for Removing Polymer Compound, Intermediate Thin Film, and/or Organic Compound>

The producing method of the invention comprises removing the polymer compound, the intermediate thin film, and/or the organic compound contained in the organic/metal oxide composite thin film from the body comprising the metal oxide thin film or organic/metal oxide composite thin film on the plugged porous substrate or the intermediate thin film.

By removing the polymer compound from the porous substrate plugged with the polymer compound or by removing the intermediate thin film formed on the porous substrate, the metal oxide thin film or organic/metal oxide composite thin film can be formed on the porous substrate having a large number of pores. By removing the polymer compound or the intermediate thin film, and the organic compound in the organic/metal oxide composite thin film, the organic compound is completely or partly removed from the composite thin film, and an amorphous organic/metal oxide composite thin film can be formed on the porous substrate having a large number of pores.

As the method for removing the polymer compound, the intermediate thin film, and/or the organic compound in the organic/metal oxide composite thin film, various treatments such as oxygen plasma treatments, ozone oxidation treatments, burning treatments, and dissolution treatments can be selected singly or used in combination. Preferred among the above treatments are the oxygen plasma treatments capable of removing at a low temperature while controlling the removing depth constant without influences on the porous substrate. Further, in the invention, the polymer compound in the porous substrate, the intermediate thin film, or the organic compound in the organic/metal oxide composite thin film can be selectively dissolved and removed by selecting an appropriate solvent.

The above treatments such as the oxygen plasma, ozone oxidation, burning, and dissolution treatments may be appropriately selected depending on the properties such as solubility and melting point of the metal compound, organic compound, and polymer used in the invention.

For example, the time, pressure, output, and temperature of the oxygen plasma treatment may be appropriately selected depending on the types and sizes of the polymer compound for plugging the porous substrate, the organic compound for the intermediate thin film, and the metal compound and the organic compound for the metal oxide thin film and organic/metal oxide composite thin film, the type and size of the organic compound the plasma source, etc. Specifically, it is appropriate that the pressure of the oxygen plasma treatment is 1.33 to 66.5 Pa (10 to 500 mTorr), preferably 13.3 to 26.6 Pa (100 to 200 mTorr). The plasma output of the oxygen plasma treatment is appropriately 5 to 500 W, preferably 10 to 50 W. The treatment time of the oxygen plasma treatment is appropriately 5 minutes to several hours, preferably 5 to 60 minutes. Further, the temperature of the oxygen plasma treatment is a low temperature, preferably −30 to 300° C., more preferably 0 to 100° C., most preferably room temperature (5 to 40° C.). A plasma apparatus for the oxygen plasma treatment is not particularly limited, and for example may be PE-2000 plasma etcher manufactured by South Bay Technology, USA, etc.

It is preferred that the burning treatment is carried out in atmosphere at a temperature of 100 to 1,000° C., preferably 300 to 500° C., for a time of 30 seconds to 1 hour, preferably 1 to 20 minutes.

The conditions of the ozone oxidation treatment may be appropriately selected depending on properties of the polymer compound, the intermediate thin film, and the organic compound contained in the organic/metal oxide composite thin film, and an apparatus for the treatment. For example, it is appropriate that the pressure of the ozone oxidation treatment is atmospheric pressure to 13.3 Pa (100 mTorr), preferably 0.013 to 13.3 Pa (0.1 to 100 mTorr). The time of the ozone oxidation treatment may be several minutes to several hours, preferably 5 to 60 minutes. The treatment temperature may be room temperature to 600° C., preferably room temperature to 400° C.

The method of the dissolution may be appropriately selected from known ones depending on the types of the components contained in the polymer compound, the intermediate thin film, or the organic/metal oxide composite thin film. For example, when the intermediate thin film is composed of an organic resist material, the organic resist material can be selectively dissolved by using a polar solvent such as acetone and ethanol. Further, the polymer compound of polystyrene can be selectively dissolved by using chloroform, toluene, etc.

[Thin Film Material of the Invention]

The thin film material of the invention may have a structure formed by removing a portion corresponding to the polymer compound or both of the polymer compound and the organic compound in the organic/metal oxide composite thin film from the body having the metal oxide thin film or organic/metal oxide composite thin film on the porous substrate having the pores plugged with at least one type of the polymer compound. Further, the thin film material of the invention may have a structure formed by removing a portion corresponding to the intermediate thin film or both of the intermediate thin film and the organic compound in the organic/metal oxide composite thin film from the body having the intermediate thin film and the metal oxide thin film or organic/metal oxide composite thin film formed in this order on the porous substrate.

“The structure formed by removing the corresponding portion” means such a structure that the polymer compound, the intermediate thin film, or the organic compound in the organic/metal oxide composite thin film is partially or completely removed to or not to form a space corresponding to the portion where the polymer compound, the intermediate thin film, or the organic compound has existed. Thus, in the structure, the metal oxide thin film or organic/metal oxide composite thin film may be formed on the porous substrate which the polymer compound in the plugged part or the intermediate thin film is removed from, and the vicinity of the portion which the organic compound in the organic/metal oxide composite thin film have existed in may be converted to the spaces, and part of the spaces corresponding to the portion or the vicinity may be connected to each other to form a network. The method for removing the corresponding portion is not particularly limited, and preferably an oxygen plasma treatment or a burning treatment.

The thin film material of the invention is preferably produced by the producing method of the invention. The thickness of the metal oxide thin film or organic/metal oxide composite thin film in the thin film material depends on the number of repeating the step of forming the thin film, and the thickness can be controlled to 300 nm or less, 2 to 200 nm, or 5 to 50 nm. In a case where the organic compound thin film is formed on the metal oxide thin film or organic/metal oxide composite thin film, the thickness of the organic compound thin film may be 1 to 200 nm, preferably 1 to 20 nm, and the total thickness of the metal oxide thin film or organic/metal oxide composite thin film and the organic compound thin film is preferably 300 nm or less.

The thin film material of the invention has self-supportability due to the above structure. The invention is not limited to a thin film material that can maintain its three-dimensional shape before and after the metal oxide thin film, the organic/metal oxide composite thin film, or a thin film prepared by removing the organic compound from the organic/metal oxide composite thin film is removed from the porous substrate, and the invention includes such a thin film material that the thin films are not assembled irreversibly and their surface areas are sufficiently larger than their thicknesses after removing the porous substrate.

In the invention, the metal oxide thin film or organic/metal oxide composite thin film can be formed directly on the porous substrate plugged with the polymer compound or on the intermediate thin film formed on the porous substrate, and the process of transferring the thin film from a solid substrate to the porous substrate can be saved, whereby a uniform thin film material with no defects can be produced with high productivity.

Further, in the invention, when the metal compound or the organic compound is brought into contact with the plugged porous substrate or the intermediate thin film-formed porous substrate by soaking the substrate in the solution containing the compound, the adsorption depends on the saturated adsorption of the substrate surface, whereby a sufficiently precision metal oxide or organic/metal oxide composite thin film can be produced without strictly determining the concentration of the metal compound or organic compound, washing temperature, hydrolyzation temperature and time, etc. On the other hand, in the case of using the spin coating method, the thickness of the adsorption layer can be controlled by changing the metal compound content of the spin coating solution, the spinning speed, the spinning time, etc.

Further, in the method of the invention, various metal oxide thin film or organic/metal oxide composite thin film can be stacked on a porous substrate with nanometer accuracy to obtain a self-supportable thin film on the substrate, whereby new electrical, electronic, magnetic, and optical functional properties can be designed. Specifically, the method can be used for producing a semiconductor superlattice material and for designing a high-efficient photochemical or electrochemical reaction. Further, the method of the invention can produce the self-supportable metal oxide thin film or organic/metal oxide composite thin film with remarkably lower costs as compared with the other methods, and thereby can provide a practical fundamental technology for light energy conversion systems such as solar cells, etc.

Further, the thin film material having the self-supportable organic/metal oxide composite thin film obtained by the method of the invention can be used as a permeable film having a nanometer-thick separation layer. In the invention, after forming the organic/metal oxide composite thin film, the incorporated organic compound can be removed under mild conditions from the thin film by the oxygen plasma or burning treatment, etc., to produce a thin film material having an amorphous self-supportable organic/metal oxide composite thin film with pores corresponding to the molecular shape of the organic compound. Such a thin film material has a density lower than those of common metal oxides, and thus the material can be used for an ultra low dielectric thin film material or for producing various sensors and is promising as an insulation material for 10- to 20-nm-patterned circuits and uneven electronic circuits or as a masking or coating film for ultrafine solid surface processing. The thin film material having the thin film can be used also as a molecular structure-selective permeable film.

Further, the composition and stack structure of the self-supportable metal oxide thin film or organic/metal oxide composite thin film can be designed in the method of the invention, so that the method can be used for producing a separation film or a reverse osmosis film for various substances. Also various functionally-graded materials can be produced by changing stacking ratio between 2 or more types of the metal compounds stepwise in the method. Further, by combining the method of the invention with successive organic compound adsorption methods that have often been reported, various organic inorganic composite ultrathin films can be designed to produce ultrathin films having novel optic, electronic, and chemical functions.

The characteristics of the invention are described in more detail below with reference to Examples. Various changes may be made on materials, amounts, ratios, treatment details, treatment procedures, etc. in Examples without departing from the scope of the invention. Thus, the following specific examples should not be considered restrictive.

### EXAMPLE 1

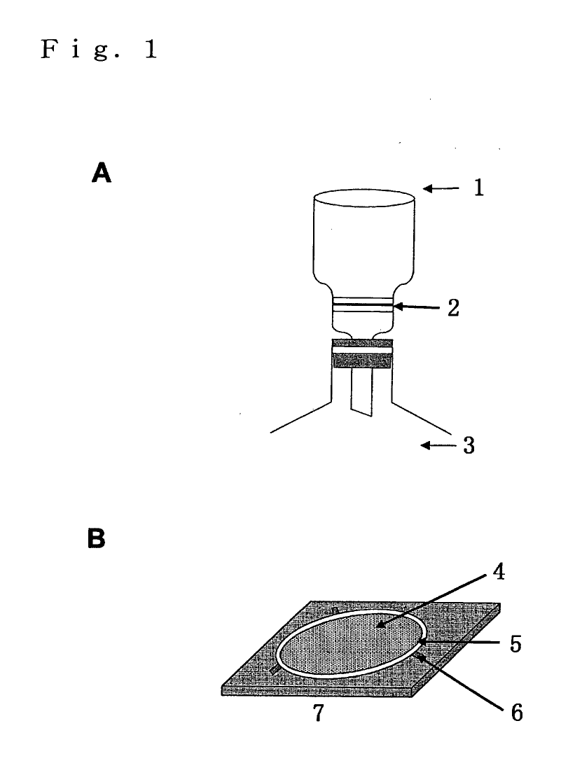

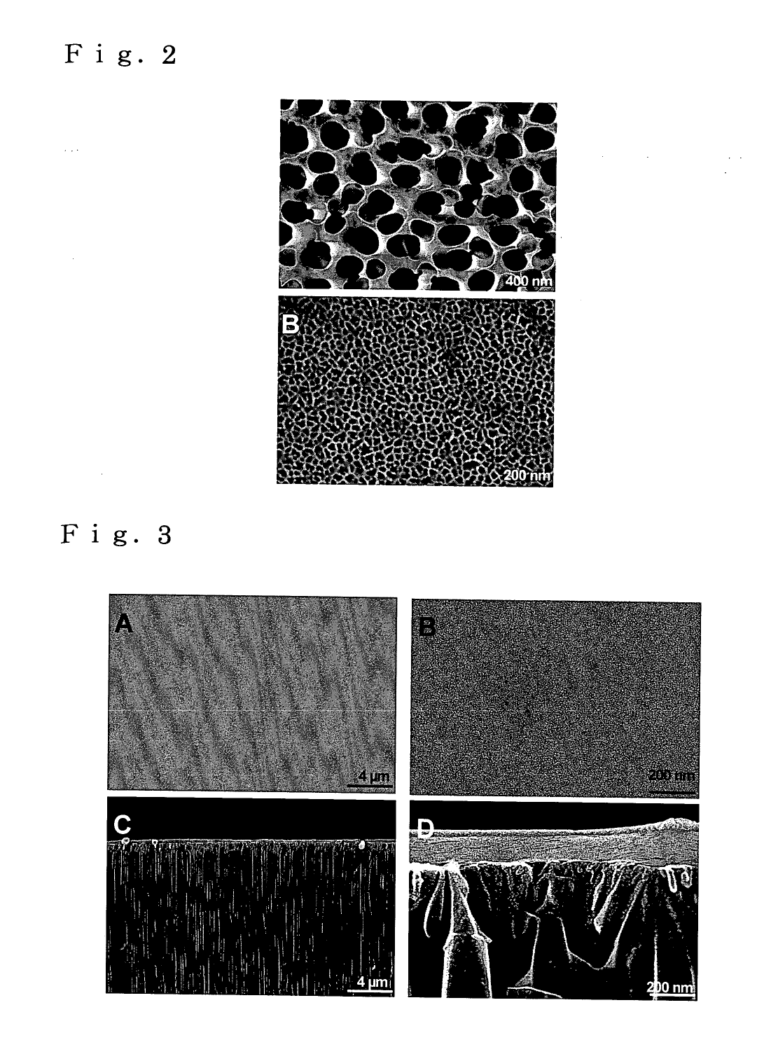

A polyethyleneimine (PEI) solution and a polyacrylic acid (PAA) solution were passed in this order through pores of a commercially available porous alumina substrate 2 (manufactured by Whatman, ANODISK™ 25 or 13, see FIG. 2) by using an apparatus shown in FIG. 1A, so that the pores in a front surface of the substrate were plugged with a double layer of PEI/PAA. The pore-plugged surface of the substrate was spin-coated with a PAA solution to prepare a substrate to be spin-coated with a titania film (FIG. 1B).

Then, the resultant substrate was spin-coated with 0.2 ml of a 100 mM titania film precursor solution (titanium butoxide, toluene:ethanol=1:1 solvent) at 3,000 rpm over 3 minutes, aged at the room temperature for 1 hour, and then subjected to the next spin coating process. The spin coating process was repeated 3 times in this manner to obtain a sample. Scanning electron microscope images of the sample are shown in FIG. 3. As shown in FIGS. 3A and 3C, the alumina substrate surface was completely covered with the titania film without defects, and the titania film was a flat uniform film having a uniform thickness over the entire film surface. Further, as shown in enlarged images obtained by a high resolution scanning electron microscope (FIGS. 3B and 3D), the film had a completely flat uniform surface and no granular structures inside the film.

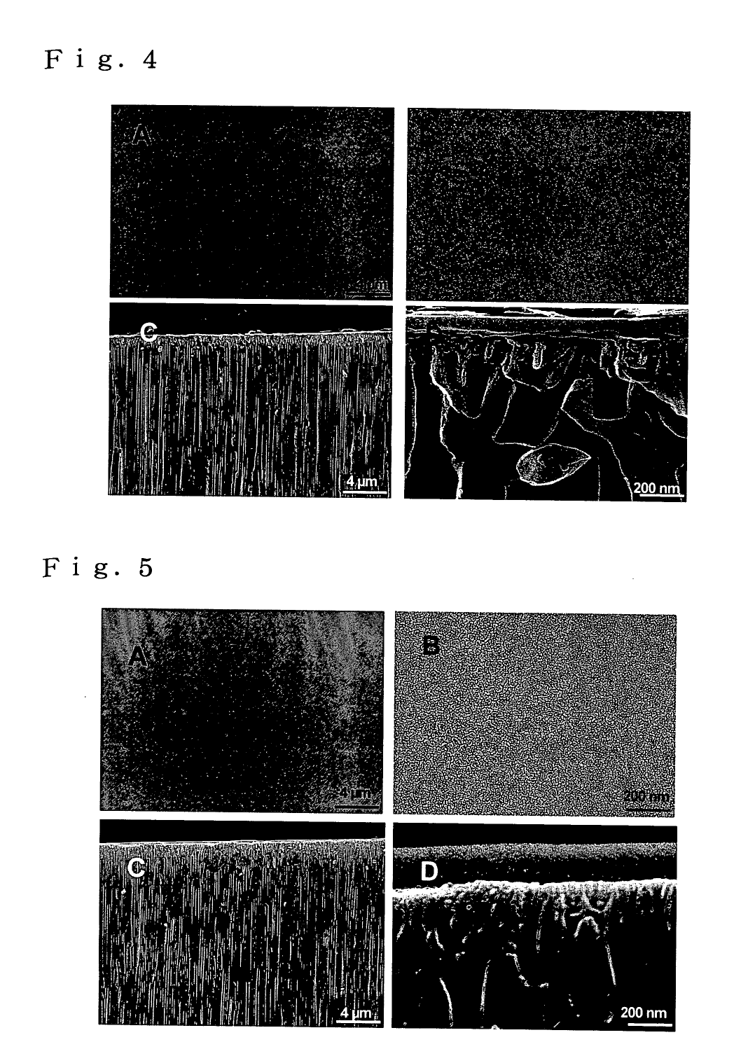

Next the above sample was subjected to an oxygen plasma treatment (frequency 13.56 MHz, oxygen pressure 23.9 Pa (180 mTorr), 30 W) using PE-2000 Plasma Etcher (South Bay Technology) to remove polymers and the other organic components from the sample. Scanning electron microscope images of the oxygen plasma-treated sample are shown in FIG. 4. The oxygen plasma-treated sample had a form approximately equal to that of untreated sample, the entire alumina substrate was covered with the flat uniform titania thin film maintaining integration structure, and no granular structure was observed inside the thin film. The titania thin film had a thickness of about 130 nm, smaller than that of the untreated sample due to the removal of the organic components (see FIG. 4D). Thus, it is clear that an approximately 45-nm-thick titanium thin film can be formed by one coating step, and the thickness of the titanium thin film can be easily controlled by changing the number of the spin coating.

### EXAMPLE 2

A self-supportable silica ultrathin film was formed on a commercially available porous alumina substrate in the same manner as Example 1 except for using a silica sol solution instead of the titanium butoxide solution as a precursor solution. The silica sol precursor solution was prepared by mixing tetramethyl orthosilicate (TMOS), methanol, ion-exchange water, and a 0.1 M aqueous hydrochloric acid at a mole ratio of 1:6:9:0.003. The obtained silica sol precursor solution had a pH value of about 3. The mixed liquid was stirred under reflux for 1 hours and left at the room temperature for 24 hours. The resultant liquid was diluted with methanol by 10 times to obtain a spin coating sol solution, which was aged for 24 hours before the use.

Scanning electron microscope images of a silica thin film obtained by repeating the spin coating 3 times are shown in FIG. 5. It is clear from FIG. 5 that the entire alumina substrate surface was covered with a flat silica film having a uniform thickness with no defects as the titania thin film of Example 1.

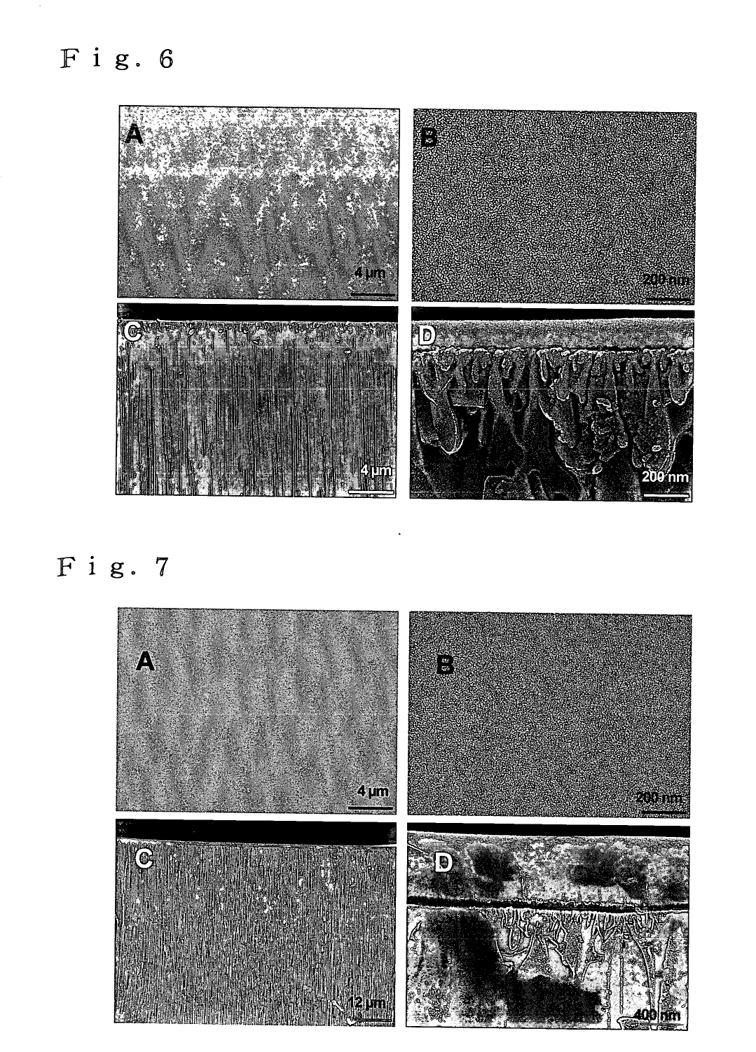

The resultant was subjected to an oxygen plasma treatment to remove the polymers and the other organic components. Scanning electron microscope images of thus obtained sample are shown in FIG. 6. The silica thin film maintained the flat integration structure completely covering the alumina substrate surface, and had open-ended cylindrical pores. This self-supportable film had a thickness of approximately 120 nm, and thus a 40-nm-thick silica film was formed by one spin coating step.

### EXAMPLE 3

A thicker self-supportable silica thin film was formed on the pore surface of the commercially available alumina substrate in the same manner as Example 2 except that the silica sol precursor solution was directly subjected to the spin coating without diluting. The silica thin film was subjected to spin coating 3 times and oxygen plasma-treated. Scanning electron microscope images of thus obtained sample are shown in FIG. 7.

The porous alumina substrate was completely covered with a self-supportable silica film, which maintained the flat uniform integration structure, as Example 2. The thickness was estimated to be about 710 nm from FIG. 7D, and thus an approximately 240-nm-thick silica thin film was formed by one spin coating process.

### INDUSTRIAL APPLICABILITY

In the producing method of the present invention, the metal oxide thin film or organic/metal oxide composite thin film is formed after plugging the pores in the surface of the porous substrate with the polymer compound or forming the intermediate thin film on the porous substrate, and the polymer compound, the intermediate thin film, and/or the organic compound are removed to form the thin film material on the porous substrate. Thus, in the producing method of the invention, the self-supportable, uniform, defectless, metal oxide thin film or organic/metal oxide composite thin film can be formed directly even on the porous substrate without separation and transfer steps of conventional methods.

Further, the thin film material of the invention has a structure formed by removing the portion corresponding to the polymer compound, the intermediate thin film, and/or the organic compound from the body comprising the metal oxide thin film or organic/metal oxide composite thin film (and the organic compound thin film) on the porous substrate having the pores plugged with the polymer compound or on the intermediate thin film formed on the porous substrate. Thus, the thin film material can contain a self-supportable metal oxide thin film or an amorphous thin film.

What is claimed is:

1. A method for producing a thin film material, comprising plugging at least pores in a surface of a porous substrate with at least one type of a polymer compound, forming a metal oxide thin film or an organic/metal oxide composite thin film on the plugged porous substrate, and removing the polymer compound or both of the polymer compound and an organic compound contained in the organic/metal oxide composite thin film.

2. A method for producing a thin film material, comprising forming an intermediate thin film on a porous substrate, forming a metal oxide thin film or an organic/metal oxide composite thin film on the formed intermediate thin film, and removing the intermediate thin film or both of the intermediate thin film and an organic compound contained in the organic/metal oxide composite thin film.

3. The method according to claim 1, wherein in the step of forming the metal oxide thin film or the organic/metal oxide composite thin film, the following processes are carried out at least once:
(a) a process of bringing a metal compound or a combination of (the metal compound+an organic compound) into contact with a surface of the substrate containing the polymer compound or a thin film, the metal compound having a group capable of undergoing a condensation reaction with a hydroxyl group or a carboxyl group on the surface and then being hydrolyzed to generate a hydroxyl group, and
(b) a process of hydrolyzing the metal compound present on the surface of the substrate or the thin film.

4. The method according to claim 3, wherein the processes of (a) and (b) are carried out a plurality of times using plural types of metal compounds or combinations of (the metal compound+an organic compound).

5. The producing method according to claim 1, wherein in the step of forming the metal oxide thin film or the organic/metal oxide composite thin film, the following processes are carried out at least once:
(a) a process of bringing a metal compound or a combination of (the metal compound+an organic compound) into contact with a surface of the substrate containing the polymer compound or a thin film, the metal compound having a group capable of undergoing a condensation reaction with a hydroxyl group or a carboxyl group on the surface and then being hydrolyzed to generate a hydroxyl group,
(b) a process of hydrolyzing the metal compound present on the surface of the substrate or the thin film, and
(c) a process of bringing a cationic polymer compound or an organic compound having a surface hydroxyl or carboxyl group into contact with the surface, to form the organic compound thin film on the surface.

6. The method according to claim 1, wherein the polymer compound, the intermediate thin film, and/or the organic compound contained in the organic/metal oxide composite thin film are removed by at least one treatment selected from oxygen plasma treatments, ozone oxidation treatments, burning treatments, and dissolution treatments.

7. A thin film material comprising a structure provided from a body comprising a porous substrate having pores plugged with at least one type of a polymer compound and a metal oxide thin film or an organic/metal oxide composite thin film formed on the porous substrate by removing a portion corresponding to the polymer compound or both of the polymer compound and an organic compound contained in the organic/metal oxide composite thin film from the body.

8. A thin film material comprising a structure provided from a body comprising an intermediate thin film and a metal oxide thin film or organic/metal oxide composite thin film formed in this order on a porous substrate by removing a portion corresponding to the intermediate thin film or both of the intermediate thin film and an organic compound contained in the organic/metal oxide composite thin film from the body.

9. The thin film material according to claim 7, wherein the thin film material has a thickness of 2 to 300 nm.

10. The thin film material according to claim 7, wherein the thin film material has an area of 25 mm² or more.

11. The thin film material according to claim 7, wherein the polymer compound, the intermediate thin film, and/or the organic compound contained in the organic/metal oxide composite thin film are removed by at least one treatment selected from oxygen plasma treatments, ozone oxidation treatments, burning treatments, and dissolution treatments.

12. A thin film material obtained by the method according to claim 1.
